(19) United States
(12) Patent Application Publication
(10) Pub. No.: US 2015/0194279 A1
(43) Pub. Date: Jul. 9, 2015

(54) COMMAND BUTTON FOR A GAME PAD AND GAME PAD EQUIPPED WITH SUCH A BUTTON

(71) Applicant: PLAYRAPID, Tarascon (FR)

(72) Inventor: Damien Rubio, Tarascon (FR)

(21) Appl. No.: 14/591,481

(22) Filed: Jan. 7, 2015

(30) Foreign Application Priority Data
Jan. 9, 2014 (FR) 1450152

(51) Int. Cl. H01H 13/14; H01H 13/10; A63F 13/24; H01H 13/50

(52) U.S. Cl. CPC H01H 13/14; H01H 13/50; H01H 13/10; A63F 13/24; H01H 2221/066; H01H 2231/008; H01H 2221/012

(57) ABSTRACT

A command button for a game pad, in the form of a joystick, including a first element, called base element, provided to be fixed in/on the pad and to interact with a detector element of the pad, and a second element, called actuator element, provided to be removably or detachably fixed on the base element.

### BACKGROUND

The present invention relates to a command button for a game pad. It also relates to a game pad equipped with such a command button.

The field of the invention is the field of input devices for controlling a games console or a computer, such as a game pad.

The majority of electronic/computer games are controlled by command input devices, such as a game pad, intended to transmit the actions of a player to the games console or the computer running the game. To this end, the game pad comprises several detector/sensor elements actuated by command buttons. Most pads comprise buttons allowing directional commands to be entered, such as directional keypads or joysticks.

Command buttons, and in particular joysticks, constitute the delicate parts of a game pad and are generally the parts of a pad which are broken or damaged first.

Furthermore, certain joysticks comprise on their upper part a covering produced in a material having specific features for grip and comfort intended to make the interaction between the command button and the fingers of a player more pleasant. As the pad is used, the covering deteriorates, to the detriment of the player's comfort.

The current solutions for repairing a broken or damaged button, or one on which the covering has deteriorated, consist of replacing the button. To this end, it is necessary to dismantle the frame of the game pad, as it is not possible to detach a command button from its sensor element without having previously removed the frame from the pad. Such an operation is time-consuming, requires special tools, and remains a complex operation which in unskilled hands presents the risk of deterioration of the game pad.

In addition, when only a part of the command button is damaged, for example the covering of the upper part of the button, the current solutions provide for the replacement of the entire button. This is costly and generates unnecessary waste.

Finally, these drawbacks are also present when a user wishes to personalize his game pad by choosing command buttons according to his preferences.

One purpose of the present invention is to overcome the aforesaid drawbacks.

Another purpose of the invention is to propose a command button the maintenance of which is less costly and less time-consuming.

Another purpose of the invention is to propose a command button that can be simply, quickly and accessibly personalized by anyone.

Finally, another purpose of the invention is to propose a command button the maintenance of which does not present any risk of deterioration for the game pad.

### SUMMARY

The invention proposes to achieve at least one of the aforementioned purposes via a command button for a game pad, and more generally for a command input device for an electronic/computerized game, characterized in that it is formed by precisely two elements:
a first element, called base element, provided to be fixed in/on said pad and to interact with a detector element of said pad, and
a second element, called actuator element, provided to be detachably or removably fixed on said base element.

Thus, the invention provides for producing a command button in precisely two elements: a base element arranged in the pad, and in particular partially under the frame of the pad and remaining fixed to the pad and an actuator element detachably/removably fixed to the base element, without the need to dismantle the frame of the pad.

Consequently, the command button according to the invention allows more cost-effective maintenance, as it makes it possible to change only the damaged/deteriorated element of the button without the need to replace the entire button.

Furthermore, the part of a button which becomes damaged the most is the upper part of the button which is in contact with the user's finger. The invention makes it possible to change this upper part, constituted by the actuator element, without the need to dismantle the base element, and consequently without the need to dismantle the frame of the pad. Thus, the button according to the invention allows maintenance to be more simply, quickly and accessibly performed by anyone and presents a reduced risk of deterioration for the pad.

Finally, the command button according to the invention allows a user to personalize it simply, quickly and without risk for the pad and to choose an actuator element according to his technical and/or purely aesthetic preferences.

According to a particularly preferred version of the invention, the actuator element is detachably fixed to the base element, thus avoiding the use of a tool for fixing or removing the actuator element.

Advantageously, the base element and/or the actuator element can comprise at least one shape, called fixing shape, produced on/around/in said element and provided for fixing the actuator element to the base element without a fixing element that is independent of said base and actuator elements.

Thus, the command button avoids manipulating a fixing element in addition to the base element and the actuator element. It is consequently easier and quicker to fix or remove the actuator element. Furthermore, the cost of the command button is reduced.

According to a particular embodiment, each of the base and actuator elements can comprise a fixing shape produced on said element and provided for fixing the actuator element to the base element.

For example, the actuator element can comprise a male fixing shape provided to engage with a female fixing shape provided on the base element.

Preferentially, the actuator element can be provided to be fixed to the base element by translation along an axis perpendicular to said base element, and more particularly an axis perpendicular to the plane in which the base element can be moved in order to enter a command.

In this version, the command button makes it possible to fix or remove the actuator element while avoiding applying force on the base element in the direction(s) in which the base element can be positioned in order to enter a command. Thus, deterioration to the base element is avoided when the actuator element is fixed or removed.

Furthermore, in this version, it is possible to replace the actuator element while the user is playing, without entering involuntary or unwanted commands.

Advantageously, at least one of the actuator or base elements can comprise a means provided to prevent the rotation of the actuator element with respect to the base element about a mutual axis of assembly of said elements.

Such an element makes it possible to avoid the actuator element moving with respect to the base element when the command button is manipulated by the user.

Alternatively, the actuator element is provided to be fixed on the base element by rotation about an axis perpendicular to said base element. This alternative makes it possible to adjust the overall height of the command button. However, in this alternative there is a risk of deterioration of the command button by applying rotational force to the base element.

Advantageously, at least one of the actuator or base elements comprises a means, called locking means, provided for locking the actuator element on the base element when said elements are assembled together. Such a locking element makes it possible to avoid the actuator element inadvertently becoming detached from the base element when the command button is operated by the user.

Such a locking element can be produced in a single piece with the base element and/or the actuator element.

The locking element can be utilized or actuated by applying an additional force, for example exerted in the direction of assembly. In this case, disassembly of the actuator element from the base element will also require an additional force in the same direction and in the opposite direction.

The locking element can be produced by a projecting shape, provided on one of the actuator or base elements, coming to lodge in a recess produced on the other one of the actuator or base elements, following application of a force greater than that exerted when the elements are assembled.

The button according to the invention can be presented for example in the form of an element that can be positioned in at least two directions, such as a directional keypad or a joystick, in order to produce a directional command.

According to a preferred embodiment of the command button that is in no way limitative:
the base element can comprise a substantially C-shaped recess;
the actuator element can comprise a C-shaped male part having dimensions that are complementary to those of said recess, provided to engage with said recess in order to carry out the fixing of said actuator element to said base element and to prevent the rotation of said actuator element with respect to said base element about the axis of assembly.
   Furthermore, the actuator element can comprise a recess, produced in the base of the male part and provided to receive a projecting shape, produced at the end of the central part of the C-shaped recess in order to carry out the locking of the actuator element to the base element. To this end, the recess produced in the base of the male part has a cross section with dimensions less than the cross section of the projecting shape so that the projecting shape is tightly lodged in said recess.

According to another aspect of the invention, a game pad is proposed comprising at least one command button according to the invention.

Advantageously, the game pad can comprise a directional button, of the directional keypad or joystick type, according to the invention.

### BRIEF DESCRIPTION OF THE DRAWINGS

Other advantages and features will become apparent on examination of the detailed description of embodiments that are no way limitative and of the attached drawings in which:

FIGS. 1 and 2 are diagrammatic representations of a first embodiment of a command button according to the invention; and

FIGS. 3 and 4 are diagrammatic representations of two preferred embodiments of a command button according to the invention.

### DETAILED DESCRIPTION

It is well understood that the embodiments that will be described hereinafter are in no way limitative. Variants of the invention can in particular be envisaged comprising only a selection of the features described below in isolation from the other described features, if this selection of features is sufficient to confer a technical advantage or to differentiate the invention with respect to the state of the prior art. This selection comprises at least one preferably functional feature without structural details, or with only a part of the structural details if this part is the one uniquely sufficient to confer a technical advantage or to differentiate the invention with respect to the state of the prior art.

In particular, all the described variants and embodiments may be combined if there is no objection to this combination from a technical point of view.

In the figures and in the remainder of the description, the elements common to several figures retain the same references.

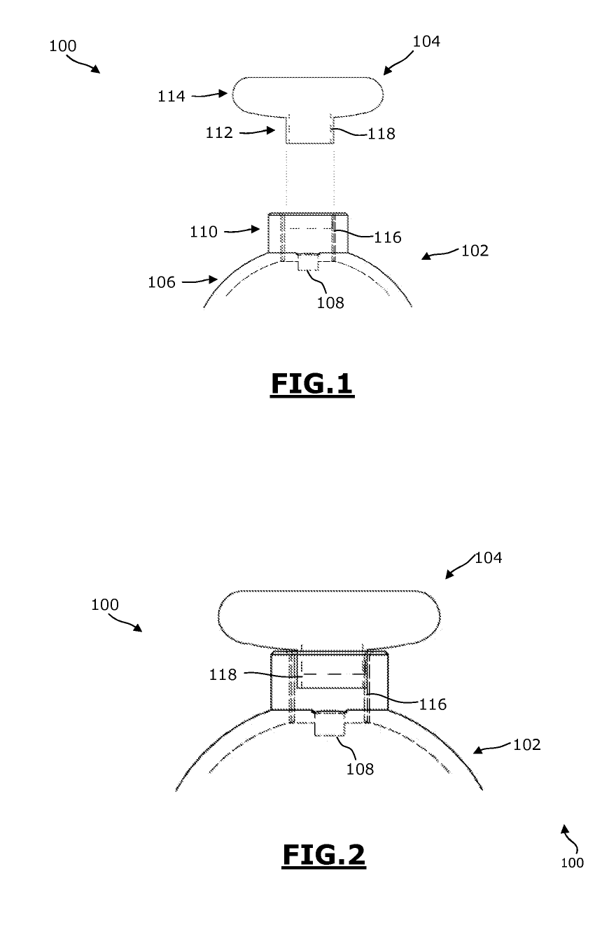

FIG. 1 is a diagrammatic representation of a first example of a button according to the invention in which the two elements forming the button are not fixed.

FIG. 2 is a diagrammatic representation of the button of FIG. 1 in which the two elements forming the button are removably fixed together.

The button 100 shown in FIGS. 1 and 2 comprises a base element 102 and an actuator element 104.

The base element 102 is provided to be fixed in a game pad, and in particular partially under the frame of the game pad, so that it cannot be dismantled from the pad without dismantling the frame of the pad. It comprises a lower part 106 provided to be fixed to a sensor element which engages in a recess 108 produced in its lower part 106 and an upper part 110 provided to fix the actuator element 104 detachably therein.

The actuator element 104 comprises a lower part 112 provided to fix it detachably to the base element 102, and an upper part 114, provided to come into contact with one of the user's fingers, allowing a user to move the button 100 in order to enter directional commands.

The base element 102 comprises in its upper part 108 an internal thread 116 provided to engage with an external thread 118 provided on the lower part 112 of the actuator element in order to fix the actuator element 104 detachably to the base element 102. Thus the actuator element 104 is fixed to the base element 102 by rotation, allowing the external thread 118 to engage with the internal thread 116.

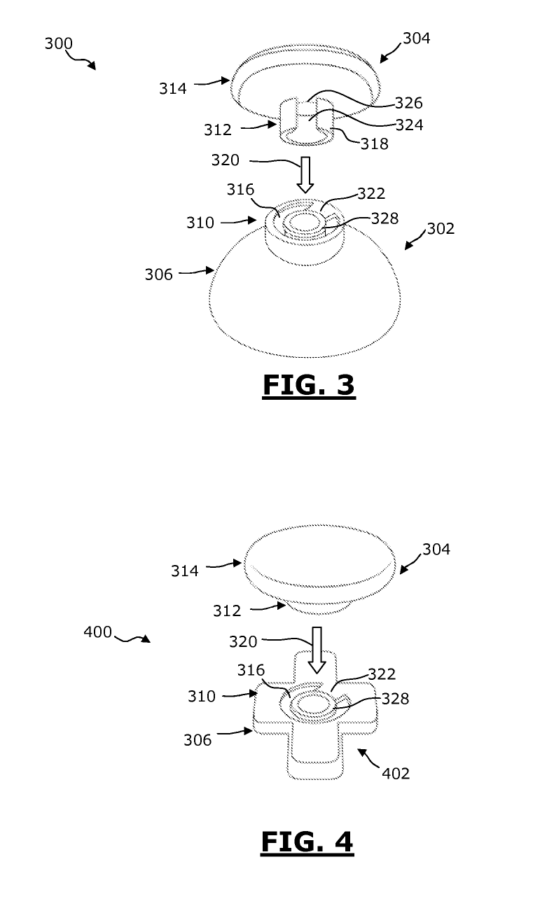

FIG. 3 is a diagrammatic representation of a preferred embodiment in the case where the button is a joystick allowing directional commands to be entered.

The button 300 shown in FIG. 3 comprises a base element 302 and an actuator element 304.

The base element 302 is provided to be fixed in a game pad, and in particular partially under the frame of the game pad, so that it cannot be dismantled from the pad without dismantling the frame of the pad. It comprises a lower part 306 provided to be fixed to a sensor element which engages in a recess (not shown) produced in its lower part 306 and an upper part 310 provided to fix the actuator element 304 detachably therein.

The actuator element 304 comprises a lower part 312 provided to fix it detachably to the base element 302, and an upper part 314, provided to come into contact with one of the user's fingers, allowing a user to move the button 300 in order to enter directional commands.

The base element 302 comprises in its upper part 310 a C-shaped recess 316 forming a female fixing shape and provided to receive a C-shaped male fixing shape 318 formed on the lower part 312 of the actuator element 304. The actuator element 304 is assembled with the base element 302 by sliding the male fixing shape 318 into the recess 316 substantially in a straight-line direction symbolized by the arrow 320.

Furthermore, the upper part 310 of the base element 302 comprises, between the arms of the C-shaped recess, material constituting a stop 322, that is positioned in the space 324 located between the arms of the C-shaped male form 318 formed on the lower part 312 of the actuator element 304 so as to prevent the rotation of the actuator element 304 with respect to the base element 302 about the direction 320.

Moreover, the actuator element 304 comprises a recess 326 provided at the base of the male fixing shape 318 and provided to receive the top 328 of the central part of the C-shaped recess. This top 328 has a diameter substantially greater than the diameter of the recess 326 so that it is inserted into the recess 326 by applying a force greater than necessary for the assembly of the actuator 304 and base 302 elements. Thus, the recess 326 and the top 328 form a means of locking the actuator element 304 to the base element 302, avoiding inadvertent disassembly of these elements.

FIG. 4 is a diagrammatic representation of the preferred embodiment described with reference to FIG. 3 in the case where the button is a directional keypad.

The button 400 shown in FIG. 4 comprises all the elements of the button in FIG. 3 with the exception that it comprises a base element 402 which is a directional keypad and the actuator element 304 is fixed to the base element 402 substantially on a central area of the directional keypad 402.

Of course, the invention is not limited to the examples that have just been described.

1. A command button for a game pad, in the form of a joystick, comprising:
a first element, called base element, provided to be fixed in/on said pad and to interact with a detector element of said pad, and
a second element, called actuator element, provided to be removably or detachably fixed on said base element.

2. The button according to claim 1, characterized in that the base element and/or the actuator element comprises at least one shape, called fixing shape, produced on/around/in said element and provided for fixing the actuator element to the base element without a fixing element that is independent of said base elements and actuator.

3. The button according to claim 1, characterized in that each of the base and actuator elements comprises a shape, called fixing shape, produced on said element and provided for fixing the actuator element to the base element.

4. The button according to claim 1, characterized in that the actuator element comprises a male fixing shape provided to engage with a female fixing shape provided on the base element.

5. The button according to claim 1, characterized in that the actuator element is provided to be fixed to the base element by translation along an axis perpendicular to said base element.

6. The button according to claim 1, characterized in that at least one of the actuator or base elements comprises a means provided to prevent the rotation of the actuator element with respect to the base element about a mutual axis of assembly of said elements.

7. The button according to claim 1, characterized in that at least one of the actuator or base elements comprises a means, called locking means, provided for locking the actuator element on the base element when said elements are assembled together.

8. The button according to claim 1, characterized in that:
the base element comprises a substantially C-shaped recess;
the actuator element comprises a C-shaped male part having dimensions that are complementary to those of said recess, provided to engage with said recess in order to fix said actuator element to said base element and prevent the rotation of said actuator element with respect to said base element.

9. A game pad comprising at least one command button according to claim 1.
